(19) United States
(12) Patent Application Publication
(10) Pub. No.: US 2007/0091285 A1
(43) Pub. Date: Apr. 26, 2007

(54) LCOS optical engine illumination system

(75) Inventors: Kau-Shen Teng, Hsinchu (TW); Wen Shan Fang, Tucheng City (TW); Chih Hung Chang, MiaoLi (TW); Ling-yuan Tseng, Saratoga, CA (US); TzuYi Chiu, Sijhih City (TW); Wan-Ching Tseng, Fongyuan City (TW)

Correspondence Address: PATENT LAW GROUP LLP, 2635 NORTH FIRST STREET, SUITE 223, SAN JOSE, CA, 95134, US

(73) Assignee: Taiwan Micro Display Corporation

(21) Appl. No.: 11/255,564

(22) Filed: Oct. 20, 2005

(51) Int. Cl. G03B 21/00

(52) U.S. Cl. 353/121

(57) ABSTRACT

An optical engine includes adjustable optics that provide rapid and accurate alignment to imagers. The adjustable optics include a light pipe translatable along a first direction, (2) a focusing lens translatable along second and third directions, (3) a turning mirror translatable along the first, the second, and the third directions, and rotatable about the first and the second directions, and (4) an adjustable dichroic mirror rotatable about the third direction. The light pipe homogenizes light from a light source, the focusing lens focuses the homogenized light, a fixed dichroic mirror passes a first color light and reflects second and third color lights from the focused light, the turning mirror turns the second and the third color lights, and the adjustable dichroic mirror passes the second color light and reflects the third color light. The imagers reflect the color lights to form color images that combine to form a projected image.

### FIELD OF INVENTION

This invention relates to optical engines for displays, including rear projection televisions.

### DESCRIPTION OF RELATED ART

U.S. Pat. No. 6,857,752 discloses various optical engines. Particularly, FIGS. 7 and 8 illustrate systems that utilize three imagers to project video images. With the high number of optical components in each system, the alignment of the optical components becomes slow and difficult. Thus, what are needed are an apparatus and a method that provide rapid and accurate alignment of the optical components in an optical engine.

### SUMMARY

In one embodiment of the invention, an optical engine includes adjustable optical components that provide rapid and accurate alignment of color lights to imagers. A light pipe homogenizes light from a light source, a focusing lens focuses the homogenized light, a first dichroic mirror passes a first color light and reflects second and third color lights from the focused light, a turning mirror turns the second and the third color lights, and a second dichroic mirror passes the second color light and reflects the third color light. The imagers reflect the color lights to form color images that combine to form a projected image.

In one embodiment, the light pipe is translatable along a first direction to match the focal point of the light source. The focusing lens is translatable along second and third directions to match the first color light to a first imager. The turning mirror is (1) translatable along the first, the second, and the third directions, and (2) rotatable about the first and the second directions, to match the second color light to a second imager. The second dichroic mirror is rotatable about the third direction to match the third color light to a third imager.

### BRIEF DESCRIPTION OF THE DRAWINGS

FIG. 1A illustrates a block diagram of an optical engine in one embodiment of the invention.

FIG. 1B illustrates a side view of the optical engine of FIG. 1A in one embodiment of the invention.

FIGS. 2A and 2B illustrate assembled and exploded view of an adjustable light pipe holder in one embodiment of the invention.

FIGS. 3A and 3B illustrate assembled and exploded view of an adjustable focus lens holder in one embodiment of the invention.

FIGS. 4A and 4B illustrate assembled and exploded view of an adjustable turning mirror holder in one embodiment of the invention.

FIGS. 5A and 5B illustrate assembled and exploded view of an adjustable dichroic mirror holder in one embodiment of the invention.

FIG. 6 illustrates a flowchart of a method for calibrating the optical engine of FIG. 1A in one embodiment of the invention.

Use of the same reference numbers in different figures indicates similar or identical elements.

### DETAILED DESCRIPTION

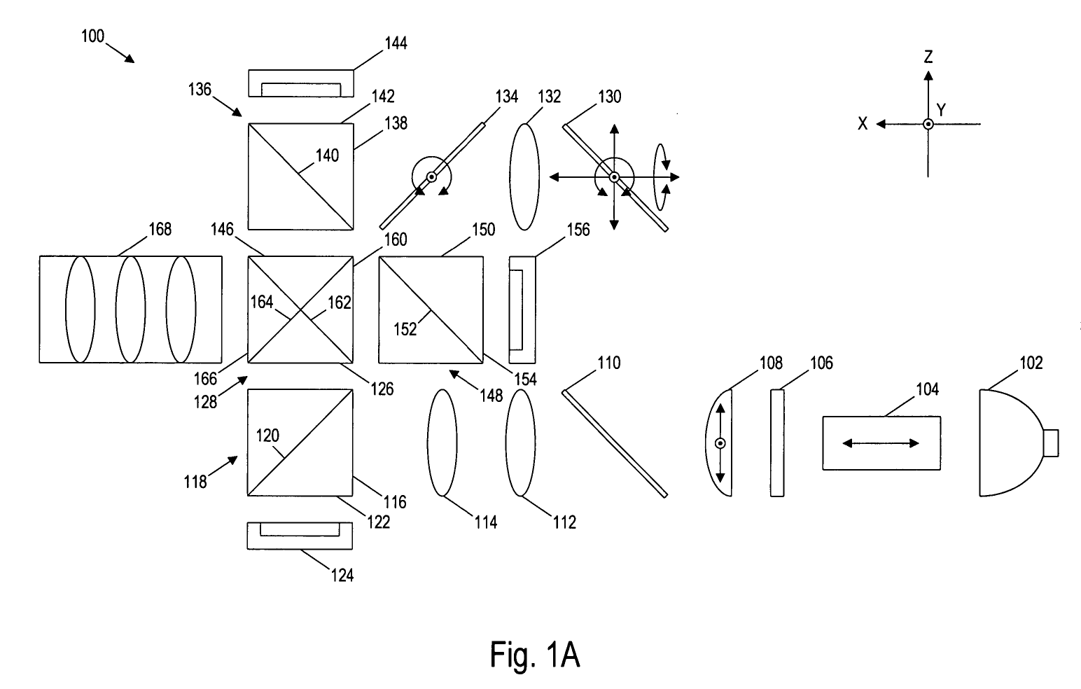

FIGS. 1A and 1B illustrate an optical engine 100 in one embodiment of the invention. Optical engine 100 provides rapid and accurate alignment of color lights onto imagers.

Optical engine 100 includes a UHP (ultra-high performance) lamp 102 that generates white light. Lamp 102 includes an elliptical reflector that focuses the white light to the input end of a light pipe 104. Note that other light sources may be used in place of lamp 102, and other light integrators may be used in place of light pipe 104.

Light pipe 104 homogenizes the intensity of the white light. Uniform white light exits generally along the positive X-direction from the output end of light pipe 104. In one embodiment, light pipe 104 is made of glass and has a rectangular cross-section to generate either a rectangular white light having the aspect ratio of the display (e.g., 16:9 or 4:3). To accommodate variations in each lamp 102, the location of light pipe 104 along the X-direction can be adjusted to align the input end of light pipe 104 to the focal point of lamp 102.

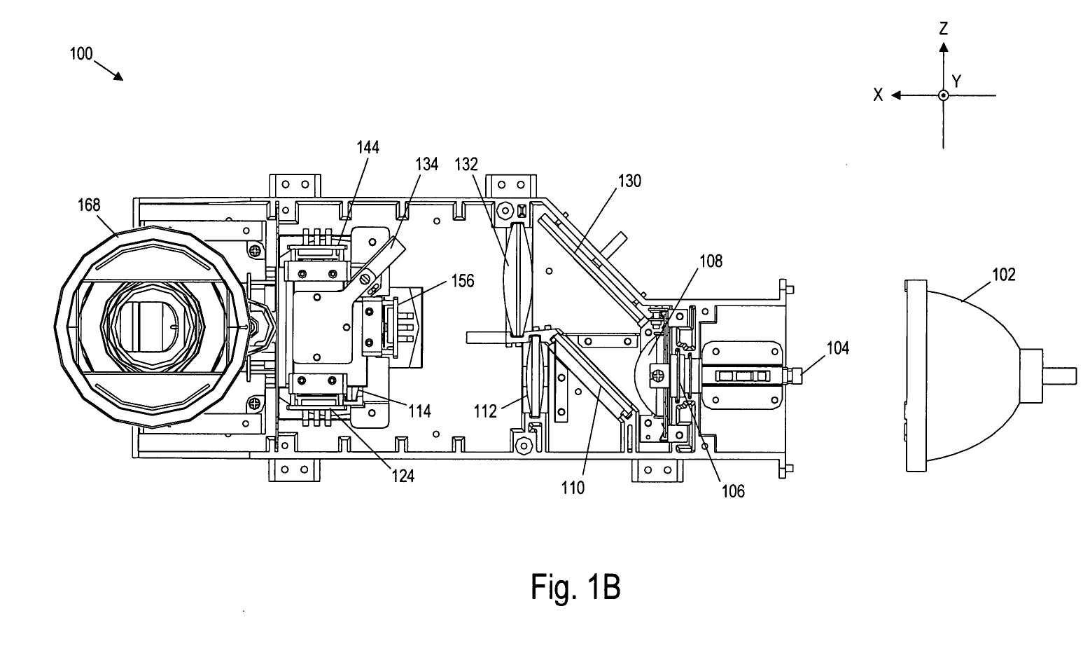

Referring to FIGS. 2A and 2B, an adjustable light pipe holder 200 provides the mechanism for adjusting the location of light pipe 104 in one embodiment of the invention. Light pipe holder 200 includes a sleeve 202 and a bracket 204. Sleeve 202 encases light pipe 104 and has a vertical tab 206 that extends from the body of sleeve 202. Bracket 204 defines a guide 208 along the X-direction for receiving sleeve 202. Guide 208 defines a slot 210 from which vertical tab 206 passes through. The location of light pipe 104 along the X-direction is adjusted by sliding vertical tab 206 to translate sleeve 202 in guide 208 of bracket 204. The location of light pipe 104 is fixed by applying adhesive (e.g., UV glue) between the bottom of tab 206 and slot 210.

Referring back to FIGS. 1A and 1B, a polarizer 106 receives the uniform white light from light pipe 104 and passes part of the white light having one polarization (e.g., s-polarized white light). Polarizer 106 may be a wire-grid polarizer made of glass embedded with fine aluminum ribbons.

A focusing lens 108 receives the s-polarized white light from polarizer 106 and focuses the white light generally along the positive X-direction. Focusing lens 108 may be an aspheric lens. To accommodate variations in the components of engine 100, the location of focusing lens 108 along the Y and the Z-directions can be adjusted to align a red color light to an imager 124.

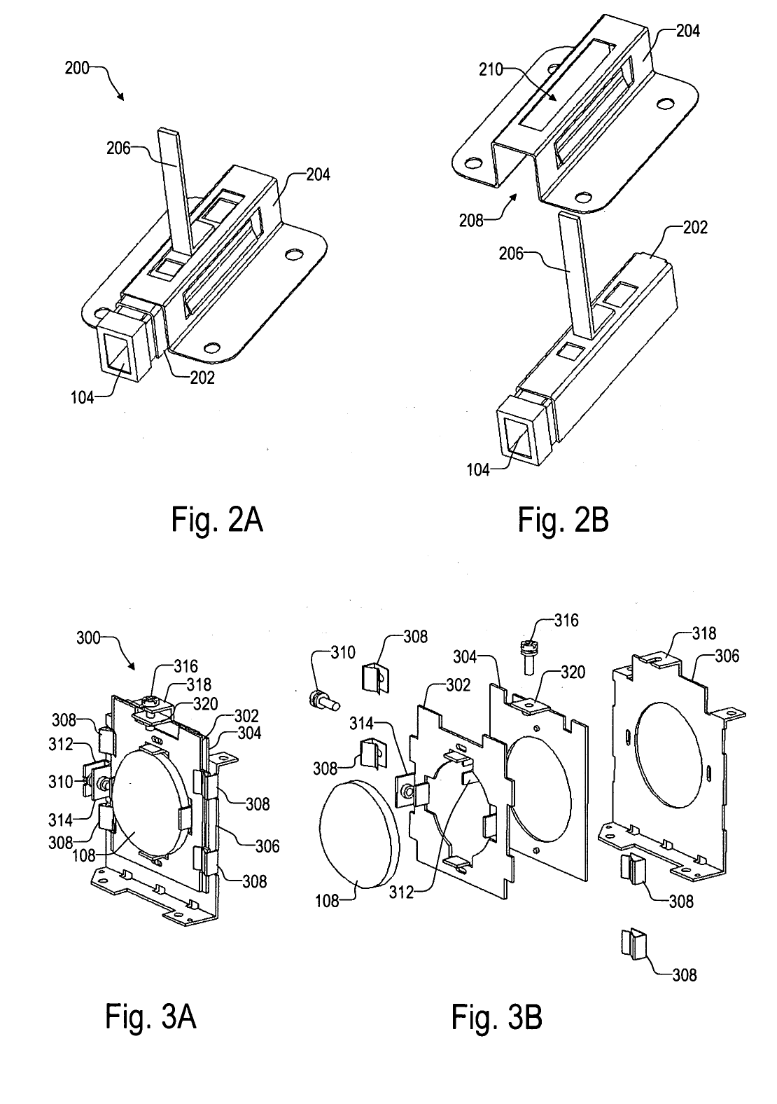

Referring to FIGS. 3A and 3B, an adjustable focusing lens holder 300 provides the mechanism for adjusting the location of focusing lens 108 along the Y and the Z-directions. Focusing lens holder 300 includes a top plate 302, a mid plate 304, and a base plate 306 held together with clips 308 on the sides of the plates. Top plate 302 includes retainers for holding focusing lens 108. A screw 310 passes through a tab 312 of mid plate 304 and threads onto a tab 314 of top plate 302. By turning screw 310, the location of lens 108 along the Y-direction is adjusted. A screw 316 passes through a tab 318 of base plate 306 and threads onto a tab 320 of mid plate 304. By turning screw 316, the location of lens 108 along the Z-direction is adjusted.

Referring back to FIGS. 1A and 1B, a dichroic mirror 110 receives the white light from focusing lens 106. In one embodiment, dichroic mirror 110 passes the red light and reflects blue and green lights. Oriented at 45 degrees to the X and the Y plane, dichroic mirror 110 passes the red light generally along the positive X-direction and reflects the blue and the green light generally along the positive Z-direction. Note that other color separators may be used in place of dichroic mirror 110.

Following the path of the red light, a pair of relay lenses 112 and 114 passes the red light generally along the positive X-direction to an input face 116 of a polarizing beam splitter (PBS) 118 (only visible in FIG. 1A). Relay lenses 112 and 114 eliminate any differences in the shape of the red light from the blue and the green lights due to their different optical paths. The red light will be uniform and collimated after passing through lenses 108, 112, and 114. In one embodiment, relay lenses 112 and 114 are spherical lenses. PBS 118 has a polarizing surface 120 (only visible in FIG. 1A) that reflects the s-polarized red light generally along the negative Z-direction through an imager face 122 (only visible in FIG. 1A).

A liquid crystal on silicon (LCOS) imager 124 is located opposite of imager face 122 to receive the s-polarized red light. In one embodiment, LCOS imager 124 is mounted on imager face 122. LCOS image 124 reflects the s-polarized red light and modulates part of the s-polarized red light to generate a red image having p-polarized red light. The red image travels in the positive Z-direction back towards PBS 118. Polarizing surface 120 of PBS 118 passes the red image having the p-polarized red light to an input face 126 (only visible in FIG. 1A) of an X-cube color combiner 128 (only visible in FIG. 1A). In one embodiment, PBS 118 is mounted on input face 126. Note that other types of imagers may be used in place of LCOS imager 124.

Referring back to the path of the blue and green lights, a turning mirror 130 reflects the blue and green lights generally along the positive X-direction. To accommodate variations in the components of engine 100, the location of turning mirror 130 along the X, Y, and Z-directions, and the angle of turning mirror 130 about the X and the Y-directions, can be adjusted to align the blue color light to an imager 144.

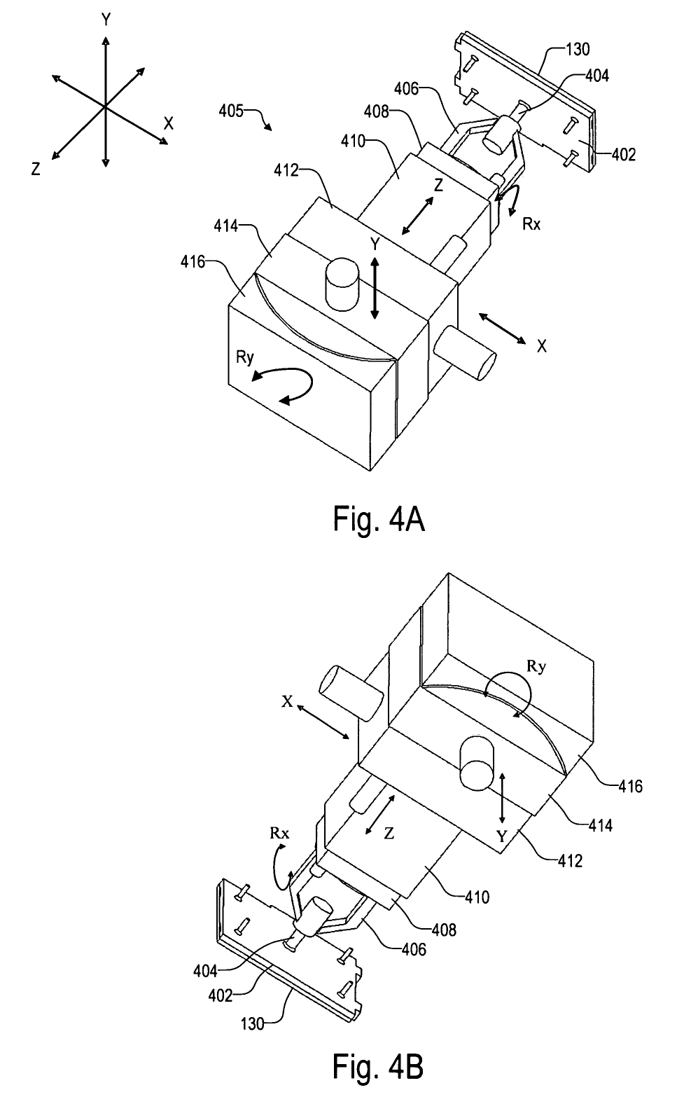

Referring to FIGS. 4A and 4B, mirror 130 is mounted on a plate 402. Plate 402 has a pole 404 extending from an opposite surface. An adjustable mirror holder 405 provides the mechanism for adjusting the location of turning mirror 130 along the X, the Y, and the Z-directions, and the angle of turning mirror 130 about the X and the Y-directions. Pole 404 from plate 402 is received by a grip 406 mounted on a goniometer 408 that provides rotation about the X-direction. Goniometer 408 has a base and a table that rotates about the base when a knob is turned. Goniometer 408 is mounted on a stage 410 that provides translation along the Z-direction when a knob is turned. Stage 410 is mounted on a stage 412 that provides translation along the X-direction when a knob is turned. Stage 412 is mounted on a stage 414 that provides translation along the Y-direction when a knob is turned. Stage 414 is mounted on a goniometer 416 that provides rotation about the Y-direction when a knob is turned. Thus, adjustable mirror holder 403 provides 5-degrees of freedom to turning mirror 130. In one embodiment, adjustable mirror holder 405 is part of optical engine 100. In another embodiment, adjustable mirror holder 405 is only used to adjust turning mirror 130 during the manufacturing of optical engine 100 and is removed after turning mirror 130 is fixed to optical engine 100.

Referring back to FIGS. 1A and 1B, a relay lens 132 passes the blue and the green lights generally along the positive X-direction. In one embodiment, relay lens 132 is an aspheric lens. The green light will be uniform and collimated after passing through lenses 108 and 132.

A dichroic mirror 134 receives the blue and the green lights from relay lens 132. In one embodiment, dichroic mirror 134 passes the blue light and reflects the green light. Oriented about 45 degrees to the X and Y plane, dichroic mirror 134 passes the blue light generally along the positive X-direction and reflects the green light generally along the negative Z-direction. To accommodate variations in the components of engine 100, the angle of dichroic mirror 134 about the Y-direction can be adjusted to align the green color light to an imager 156. Note that other color separators may be used in place of dichroic mirror 134.

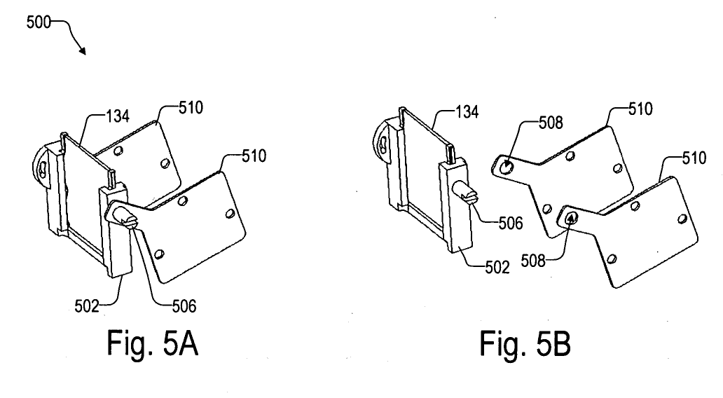

Referring to FIGS. 5A and 5B, an adjustable dichroic mirror holder 500 provides the mechanism for adjusting the angle of dichroic mirror 134 about the Y-direction. A support frame 502 comprises slotted sides for receiving dichroic mirror 134. Support frame 502 further includes pins 506 along the sides, which are received by bores 508 in brackets 510 so that mirror frame 502 can rotate about the Y-direction. In one embodiment, brackets 510 are mounted on color combiner 128. The angle of dichroic mirror 134 is fixed by applying adhesives to pins 506 and bores 508.

Referring back to FIG. 1A and following the path of the blue light, a PBS 136 receives the blue light at an input face 138. PBS 136 has a polarizing surface 140 that reflects the s-polarized red light generally along the positive Z-direction through an imager face 142.

A LCOS imager 144 is located opposite of imager face 142 to receive the s-polarized blue light. In one embodiment, LCOS imager 144 is mounted on imager face 142. LCOS image 144 reflects the s-polarized blue light and modulates part of the s-polarized blue light to generate a blue image having p-polarized red light. The blue image travels in the negative Z-direction back towards PBS 136. Polarizing surface 140 of PBS 136 passes the blue image having the p-polarized blue light to an input face 146 of color combiner 128. In one embodiment, PBS 136 is mounted on input face 146. Note that other types of imagers may be used in place of LCOS imager 144.

Following the path of the green light, a PBS 148 receives the green light at an input face 150. PBS 148 has a polarizing surface 152 that reflects the s-polarized green light generally along the negative X-direction through an imager face 154.

A LCOS imager 156 is located opposite of imager face 154 to receive the s-polarized green light. In one embodiment, LCOS imager 156 is mounted on imager face 154. LCOS image 156 reflects the s-polarized green light and modulates part of the s-polarized green light to generate a green image having p-polarized green light. The green image travels in the positive X-direction back towards PBS 148. Polarizing surface 152 of PBS 148 passes the green image having the p-polarized green light to an input face 160 of color combiner 128. In one embodiment, PBS 148 is mounted on input face 160. Note that other types of imagers may be used in place of LCOS imager 156.

Color combiner 128 has a dichroic coating on a diagonal face 162 that reflects red light and passes blue and green lights, and a dichroic coating on a diagonal face 164 that reflects blue light and passes red and green lights. The red image from imager 124 reflects from diagonal face 162 and leaves through an exit face 166. The blue image from imager 144 reflects from diagonal face 164 and leaves through exit face 166. The green image from imager 156 passes through diagonal faces 162 and 164 and leaves through exit face 166. At exit face 166, the red, green, and blue images merge to form a single image with the appropriate colors. The single image then travels from color combiner 128 to a projection lens 168. Note that other color combiners may be used in place of X-cube color combiner 128. In one embodiment, PBS 118, PBS 136, PBS 148, and X-cube color combiner 128 are the Vikuiti Optical Core from 3M Optical System Division of St. Paul, Minn.

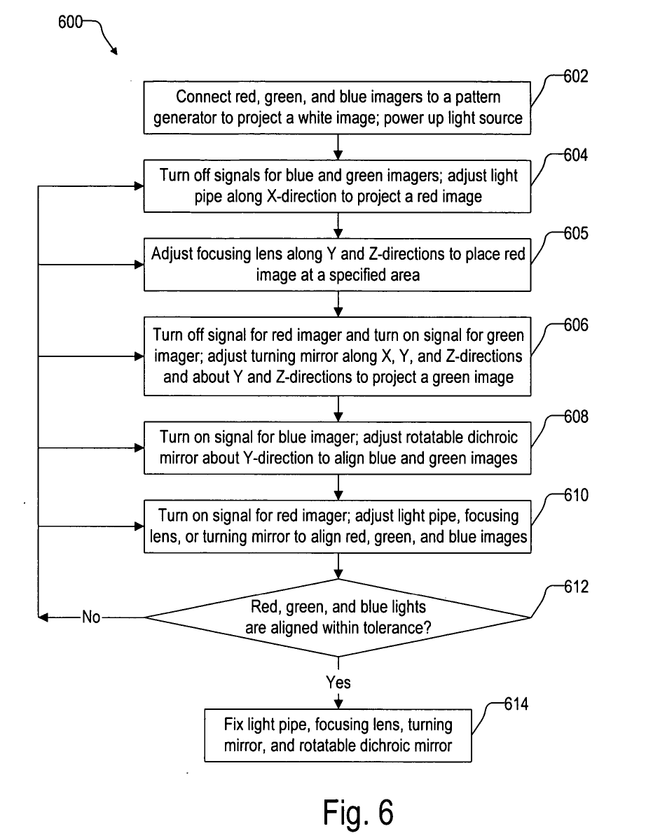

FIG. 6 illustrates a flowchart for a method 600 to align the color lights to imagers 124 144, and 156 during the manufacturing process.

In step 602, imagers 124, 144, and 156 are connected to a pattern generator to project a white image on the screen and light source 102 is powered up.

In step 604, the signals for blue imager 144 and green imager 156 are turned off and the location of light pipe 104 is adjusted along the X-direction to project a uniform and bright red image with sharp edges on the screen (i.e., to focus the red image). In one embodiment, the uniformity and brightness of the red image is measured by a light meter at 9 or 13 different points.

In step 605, the location of focusing lens 108 is adjusted along the Y and the Z-directions to move the red image to a specified area defined by the shadow mask of the resulting display.

In step 606, the signal for red imager 124 is turned off and the signal for green imager 156 is turned on to project a green image on the screen. Turning mirror 130 is adjusted along the X, Y, and Z-directions and about the X and Y-directions to (1) project a uniform and bright green image with sharp edges on the screen (i.e., to focus the green image), and (2) place the green image to the specified area defined by the shadow mask of the resulting display (i.e., to provide a rectangular shape into the specified area). In one embodiment, the uniformity and brightness of the green image is measured by a light meter at 9 or 13 different points.

In step 608, the signal for blue imager 144 is turned on to project a blue image on the screen along with the green image. Any misalignment between the blue and the green images appears visually as a blue light and a green light at the top and the bottom of the combined image, or vice versa. Dichroic mirror 134 is adjusted about the Y-direction until the blue and the green images are aligned. Note that the uniformity and brightness of the blue image are not measured because they should be the same as the uniformity and brightness of the green image, which were adjusted with turning mirror 130 in step 606.

In step 610, the signal for red imager 124 is turned on to project the red image on the screen along with the green and the blue images. At this point, one of three types of misalignment occurs. In a first type of misalignment, a cyan light (a mixture of green and blue lights) appears at two of the edges of a white image. Focusing lens 108 is adjusted along the Y and the Z-directions until a fully white image appears. In a second type of misalignment, a magenta light (a mixture of red and blue lights) appears around the edges of a white image. Turning mirror 130 is adjusted along the Z-direction until a fully white image appears. In a third type of misalignment, a cyan light appears around the edges of a white image. Light pipe 104 is adjusted along the X-direction until a fully white image appears.

In step 612, it is determined if the red, the green, and the blue images are aligned within an acceptable tolerance. If the red, the green, and the blue images are not aligned within the acceptable tolerance, then method 600 loops back to any of the above steps from step 604 to 610 to further adjust the alignment of the components. From experience, only further adjustments to turning mirror 130 and focusing lens 108 are needed to align the images within the acceptable tolerance. Step 612 is followed by step 614 if the images are aligned within the acceptable tolerance.

In step 614, the locations and positions of light pipe 104, focusing lens 108, turning mirror 130, and dichroic mirror 134 are fixed.

Various other adaptations and combinations of features of the embodiments disclosed are within the scope of the invention. Numerous embodiments are encompassed by the following claims.

What is claimed is:

1. An optical engine for a display, comprising:
a light source generating a light;
a light pipe assembly, comprising:
a light pipe located to receive the light from the light source, the light pipe homogenizing an intensity of the light;
an adjustable light pipe holder providing translational adjustment for the light pipe along a first direction;
a focusing lens assembly, comprising:
a focusing lens located to receive the light from the light pipe, the focusing lens focusing the light;
an adjustable focusing lens holder providing translational adjustment for the focusing lens along a second direction and a third direction;
a first dichroic mirror located to receive the light from the focusing lens, the first dichroic mirror passing a first color light and reflecting a second color light and a third color light;
a turning mirror assembly, comprising:
a turning mirror located to receive the second and the third color lights from the first dichroic mirror, the turning mirror turning the second and the third color lights;
an adjustable turning mirror holder providing (1) translational adjustment along the first, the second, and the third directions, and (2) rotational adjustment about the first and the second directions;
a dichroic mirror assembly, comprising:
a second dichroic mirror located to receive the second and the third color lights from the turning mirror, the second dichroic mirror passing the second color light and reflecting the third color light;
an adjustable dichroic mirror holder for providing rotational adjustment about the second direction.

2. The optical engine of claim 1, wherein the adjustable light pipe holder comprises:
a sleeve encasing the light pipe, the sleeve comprising a tab extending from a body of the sleeve;
a bracket defining a guide along the first direction for receiving the sleeve so the sleeve is able to translate along the first direction, the guide defining a slot from which the tab of the sleeve protrudes from the bracket for adjusting the sleeve along the first direction.

3. The optical engine of claim 1, wherein the adjustable focusing lens holder comprises:
a base plate comprising a first tab;
a mid plate atop the base plate, the mid plate comprising second and third tabs;
a top plate atop the mid plate, the top plate receiving the focusing lens, the top plate comprising a fourth tab;
clips holding the base, the mid, and the top plate;
a first screw passing through the first tab and threading in the second tab for adjusting the location of the focusing lens along the third direction; and
a second screw passing through the third tab and threading in the fourth tab for adjusting the location of the focusing lens along the second direction.

4. The optical engine of claim 1, wherein the adjustable turning mirror holder comprises:
a plate comprising a first surface for receiving the turning mirror and a second surface comprising a pole;
a grip receiving the pole;
a first goniometer receiving the grip, the first goniometer providing rotation about one of the first and the second directions;
three stacked translation stages receiving the first goniometer, the three stacked translation stages providing translation along the first, the second, and the third directions; and
a second goniometer receiving the three stacked translation stages, the second goniometer providing rotation about another of the first and the second direction.

5. The optical engine of claim 1, wherein the adjustable dichroic mirror holder comprises:
a support frame for receiving the dichroic mirror, the support frame comprising pins along the second directions;
a bracket comprising bores for receiving the pins so the support frame is able to rotate about the second direction.

6. The optical engine of claim 1, further comprising:
a first polarizing beam splitter (PBS) comprising a first input face, a first polarizing surface, and a first imager face, the first PBS being located so the first input face receives the first color light from the first dichroic mirror and the first polarizing surface reflects the first color light to the first imager face;
a first imager located opposite the first imager face of the first PBS, the first imager reflecting a first color image back through the first PBS;
a second PBS comprising a second input face, a second polarizing surface, and a second imager face, the second PBS being located so the second input face receives the second color light from the second dichroic mirror and the second polarizing surface reflecting the second color light to the second imager face;
a second imager located opposite the second imager face of the second PBS, the second imager reflecting a second color image back through the second PBS;
a third PBS comprising a third input face, a third polarizing surface, and a third imager face, the third PBS being located so the third input face receives the third color light from the second dichroic mirror and the third polarizing surface reflects the third color light to the third imager face;
a third imager located opposite the third imager face of the third PBS, the third imager reflecting a third color image back through the third PBS;
a color combiner comprising a first PBS face, a second PBS face, a third PBS face, a first dichroic surface, a second dichroic surface, and an exit face, wherein:
the color combiner being located so the first PBS face receives the first color image reflected through the first PBS, the second PBS face receives the second color image reflected through the second PBS, and the third PBS face receives the third color image reflected through the third PBS;
the first dichroic surface reflects the first color image to the exit face, the second dichroic surface reflects the second color image to the exit face, and the first and the second dichroic surfaces pass the third color image to the exit face;
the first, the second, and the third color images merge to form a single image that exits the color combiner through the exit face.

7. The optical engine of claim 6, further comprising a polarizer between the light pipe and the focusing lens.

8. The optical engine of claim 7, further comprising:
two relay lenses between the first dichroic mirror and the first input face of the first PBS.

9. The optical engine of claim 8, further comprising:
another relay lens between the turning mirror and the second dichroic mirror.

10. The optical engine of claim 9, further comprising:
a projection lens located to receive the combined image from the color combiner.

11. A method for aligning components in an optical engine, comprising:
powering up a light source to generate a white light, wherein the white light travels through a light pipe, a focusing lens, and onto a first dichroic mirror, the first dichroic mirror passing a first color light onto a first imager and reflecting second and third color lights, the second and the third color lights reflects from a turning mirror onto a second dichroic mirror, the second dichroic mirror passing the second color light onto a second imager and reflecting the third color light onto a third imager;
providing only a first color signal to the first imager in the optical engine to generate a first color image on a screen;
adjusting the light pipe only along a first direction to focus the first color image;
adjusting the focusing lens along second and third directions to place the first color image at an area on the screen;
providing only a third color signal to the third imager in the optical engine to generate a third color image on the screen;
adjusting the turning mirror (1) only along the first, the second, and the third directions, and (2) only about the first and the second directions, to focus the third color image and to place the third color image at the area on the screen;
providing a second color signal to the second imager and the third signal to the third imager to generate a second color image and the third color image;
adjusting the second dichroic mirror only about the second direction to align the second color image and the third color image;
providing the first color signal to the first imager, the second color signal to the second imager, and the third color signal to the third imager to generate the first, the second, and the third color images; and
adjusting at least one of the light pipe, the focusing lens, and the turning mirror to align the first, the second, and the third color images.

12. The method of claim 11, wherein said adjusting at least one of the light pipe, the focusing lens, and the turning mirror comprises:
adjusting the focusing lens along the second and the third directions when a mixture of the second and the third color lights appears at two edges of a white image on the screen.

13. The method of claim 11, wherein said adjusting at least one of the light pipe, the focusing lens, and the turning mirror comprises:
adjusting the turning mirror along the third direction when a mixture of the first and the second color lights appears around a white image on the screen.

14. The method of claim 11, wherein said adjusting at least one of the light pipe, the focusing lens, and the turning mirror comprises:
adjusting the light pipe along the first direction when a mixture of the second and the third color lights appears around a white image on the screen.

15. The method of claim 1 1, wherein the optical engine further comprises:
a first polarizing beam splitter (PBS) comprising a first input face, a first polarizing surface, and a first imager face, the first PBS being located so the first input face receives the first color light from the first dichroic mirror and the first polarizing surface reflects the first color light to the first imager face;
the first imager located opposite the first imager face of the first PBS, the first imager reflecting the first color image back through the first PBS;
a second PBS comprising a second input face, a second polarizing surface, and a second imager face, the second PBS being located so the second input face receives the third color light from the second dichroic mirror and the second polarizing surface reflecting the third color light to the second imager face;
the third imager located opposite the second imager face of the second PBS, the third imager reflecting the third color image back through the second PBS;
a third PBS comprising a third input face, a third polarizing surface, and a third imager face, the third PBS being located so the third input face receives the second color light from the second dichroic mirror and the third polarizing surface reflects the second color light to the third imager face;
the second imager located opposite the third imager face of the third PBS, the second imager reflecting the second color image back through the third PBS;
a color combiner comprising a first PBS face, a second PBS face, a third PBS face, a first dichroic surface, a second dichroic surface, and an exit face, wherein:
the color combiner being located so the first PBS face receives the first color image reflected through the first PBS, the second PBS face receives the third color image reflected through the second PBS, and the third PBS face receives the second color image reflected through the third PBS;
the first dichroic surface reflects the first color image to the exit face, the second dichroic surface reflects the third color image to the exit face, and the first and the second dichroic surfaces pass the second color image to the exit face;
the first, the second, and the third color images merge to form a single image that exits the color combiner through the exit face.

16. The method of claim 15, wherein the optical engine further comprises a polarizer between the light pipe and the focusing lens.

17. The method of claim 16, wherein the optical engine further comprises:
two relay lenses between the first dichroic mirror and the first input face of the first PBS.

18. The method of claim 17, wherein the optical engine further comprises:
another relay lens between the turning mirror and the second dichroic mirror.

19. The method of claim 18, wherein the optical engine further comprises:
a projection lens located to receive the combined image from the color combiner.

20. A method for aligning components in an optical engine, comprising:
powering up a light source to generate a light;
adjusting a light pipe only along a first direction to align a focal point of the light source to an input end of the light pipe, the light pipe homogenizing an intensity of the light;
adjusting a focusing lens only along a second direction and a third direction to align a first color light to a first imager, the focusing lens receiving the light from the light pipe and directing the light to a first dichroic mirror, the first dichroic mirror passing the first color light and reflecting a second color light and a third color light;
adjusting a turning mirror (1) only along the first, the second, and the third directions, and only (2) about the first and the second directions, to align the second color light to a second imager, the turning mirror receiving the second and the third color lights from the first dichroic mirror; and
adjusting a second dichroic mirror only about the second direction to align the third color light to a third imager, the second dichroic mirror receiving the second and the third color lights from the turning mirror, the second dichroic mirror passing the second color light and reflecting the third color light.
